(19) United States
(12) Patent Application Publication
(10) Pub. No.: US 2012/0080892 A1
(43) Pub. Date: Apr. 5, 2012

(54) DOOR HANDLE DEVICE FOR VEHICLE

(75) Inventors: Koichi NAGATA, Chiryu-shi (JP); Nobukazu ARAKI, Hekinan-shi (JP); Naoya ASANO, Ichinomiya-shi (JP)

(73) Assignee: AISIN SEIKI KABUSHIKI KAISHA, Kariya-shi (JP)

(21) Appl. No.: 13/116,078

(22) Filed: May 26, 2011

(30) Foreign Application Priority Data
Sep. 30, 2010 (JP) 2010-221652
Dec. 24, 2010 (JP) 2010-287454

(51) Int. Cl. E05B 3/00

(52) U.S. Cl. 292/336.3

(57) ABSTRACT

A door handle device for a vehicle includes a handle including an engagement leg portion and an engagement arm portion at a first side and a second side respectively in a longitudinal direction of the handle, a first frame configured to be attached to a door panel of the door and including a bearing portion serving as a rotation center of the engagement leg portion, a lever configured to transmit an opening operation force of the door to a door lock mechanism by operating with the engagement arm portion, a second frame configured to be attached to the door panel and supporting the lever to rotate at a support shaft, and a cap engaging with the second frame in a detachable manner and configured to cover an opening portion formed at the door panel through which the engagement arm portion is inserted.

### CROSS REFERENCE TO RELATED APPLICATIONS

This application is based on and claims priority under 35 U.S.C. §119 to Japanese Patent Application 2010-221652 filed on Sep. 30, 2010 and Japanese Patent Application 2010-287454 filed on Dec. 24, 2010, the entire contents of which are incorporated herein by reference.

### TECHNICAL FIELD

This disclosure generally relates to a door handle device for a vehicle.

### BACKGROUND DISCUSSION

A known door handle device for a vehicle including a grip outer handle is disclosed in JP2002-4649A (which will be hereinafter referred to as Reference 1). The door handle device disclosed in Reference 1 includes a frame fixed to a door panel of the vehicle, a lever rotatably supported by the frame, a spring biasing the lever to rotate to an initial position, and a handle causing the lever to rotate against a biasing force of the spring. The frame includes a front portion and a rear portion in a longitudinal direction of the vehicle that are integrally formed by a connection portion. The door handle device disclosed in Reference 1 further includes a temporarily holding mechanism temporarily holding the lever against the biasing force of the spring at a position determined by a predetermined rotation amount from the initial position.

In addition, a known door handle device for a vehicle disclosed in JPH10-266642A (which will be hereinafter referred to as Reference 2) includes a frame fixed to a door panel of the vehicle in which a front portion and a rear portion are separately formed. That is, the door handle device disclosed in Reference 2 includes a first frame serving as the front portion, a second frame serving as the rear portion and forming a decorative surface together with a cap, a lever rotatably supported by the second frame, a spring biasing the lever to rotate to an initial position, and a handle causing the lever to rotate against a biasing force of the spring.

According to the door handle device disclosed in Reference 1, because the frame is configured in such a manner that the front portion and the rear portion thereof are integrally formed by the connection portion, multiple frames having different lengths of connecting portions are required depending on vehicles that include different or various lengths of handles. As a result, a versatility of the frame may decrease.

According to the door handle device disclosed in Reference 2, because the second frame forms the decorative surface together with the cap, the design of the second frame needs to change in association with the change of the design of the cap. As a result, a versatility of the second frame may decrease.

A need thus exists for a door handle device for a vehicle which is not susceptible to the drawback mentioned above.

### SUMMARY

According to an aspect of this disclosure, a door handle device for a vehicle includes a handle serving as a grip portion for opening and closing a door for the vehicle and including an engagement leg portion and an engagement arm portion at a first side and a second side respectively in a longitudinal direction of the handle, a first frame configured to be attached to a door panel of the door and including a bearing portion serving as a rotation center of the engagement leg portion, a lever configured to transmit an opening operation force of the door to a door lock mechanism holding the door at a fully closed position by operating with the engagement arm portion, a second frame configured to be attached to the door panel and supporting the lever to rotate at a support shaft, and a cap engaging with the second frame in a detachable manner and formed at the second side of the handle in the longitudinal direction, the cap being configured to cover an opening portion formed at the door panel through which the engagement arm portion is inserted.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating a side surface of a door for a vehicle according to a first embodiment disclosed here;

FIG. 2 is side view of a door handle device mounted at the door illustrated in FIG. 1 according to the first embodiment;

FIG. 3 is a side view of the door handle device where a cap is removed according to the first embodiment;

FIG. 4A is an exploded perspective view of an engagement leg portion of a handle of the door handle device according to the first embodiment;

FIG. 4B is an exploded perspective view of a bearing portion of a first frame according to the first embodiment;

FIG. 5 is a perspective view illustrating a rear side of the door handle device according to the first embodiment;

FIG. 6 is a plan view of the door handle device according to the first embodiment;

FIGS. 7A and 7B are schematic views illustrating an assembly process of the door handle device according to the first embodiment, FIG. 7A illustrating a state where a second frame and a lever are assembled on each other, FIG. 7B illustrating details around a support shaft;

FIGS. 8A and 8B are schematic views illustrating the assembly process of the door handle device according to the first embodiment, FIG. 8A illustrating a state where the lever is temporarily held at the second frame, FIG. 8B illustrating details around the support shaft;

FIGS. 9A and 9B are schematic views illustrating the assembly process of the door handle device according to the first embodiment, FIG. 9A illustrating a state where an engagement arm portion and a lever input portion are in contact with each other, FIG. 9B illustrating details around the support shaft;

FIG. 10 is a side view illustrating a second frame and a lever according to a second embodiment disclosed here; and

FIG. 11 is a perspective view illustrating a state where the second frame and the lever are temporarily held at each other according to the second embodiment.

### DETAILED DESCRIPTION

First and second embodiments will be explained with reference to the attached drawings. In the embodiments, directions and orientations such as left, right, front, rear, top, and bottom correspond to those of a vehicle where a door handle device according to the embodiments is equipped.

### First Embodiment

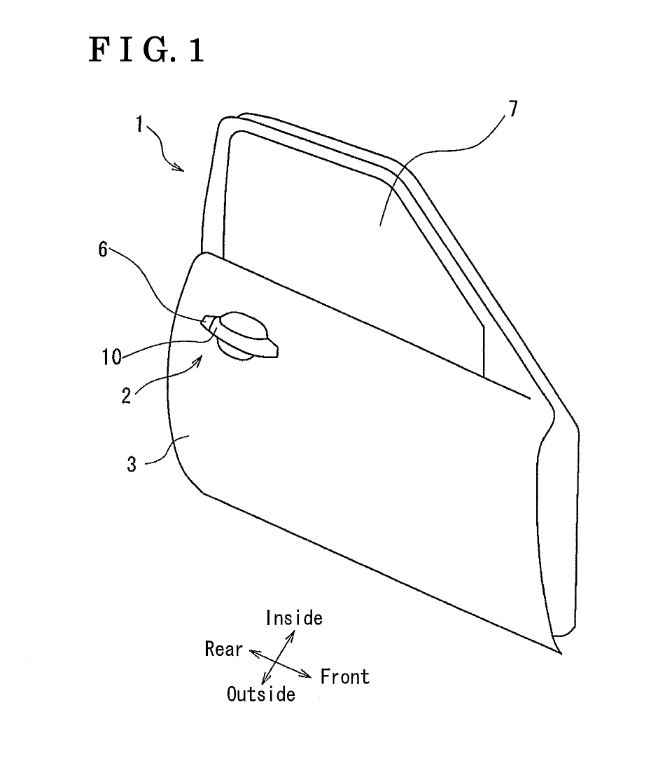

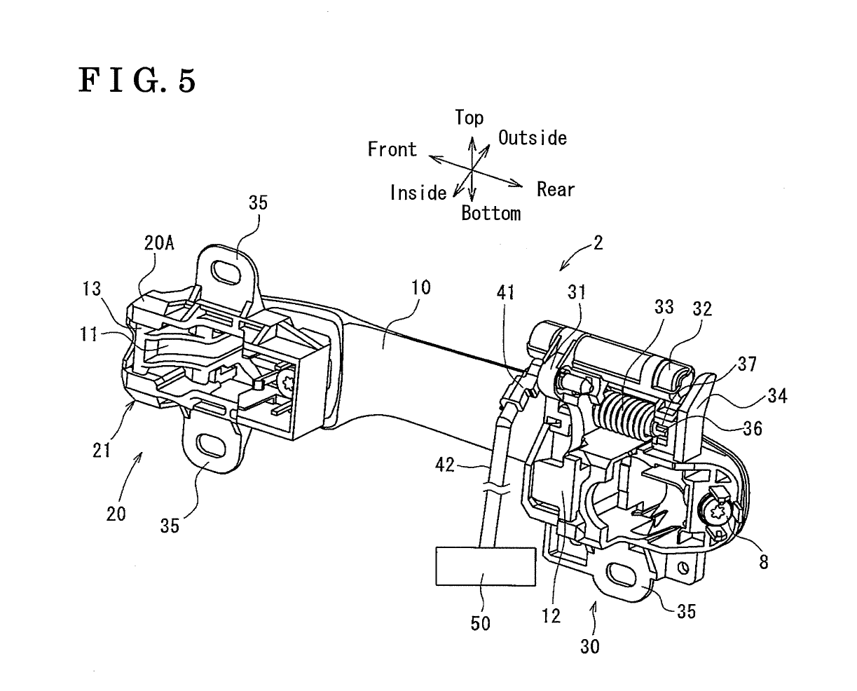

As illustrated in FIG. 1, a door 1 for a vehicle includes a door panel 3 forming a decorative surface at a vehicle outer side, and a window glass 7. A handle 10 made of resin and extending in a longitudinal direction of the vehicle is attached to the door panel 3 so as to expose to the vehicle outer side. A cap 6 is also attached to the door panel 3 while being arranged at a rear side of the handle 10 in the longitudinal direction (i.e., at a second side of the handle 10 in the longitudinal direction) so as to expose to the vehicle outer side. The handle 10 serving as a grip portion for opening and closing the door 1 is mechanically connected to a door lock mechanism 50 (see FIG. 5) holding the door 1 at a fully closed state (i.e., at a fully closed position).

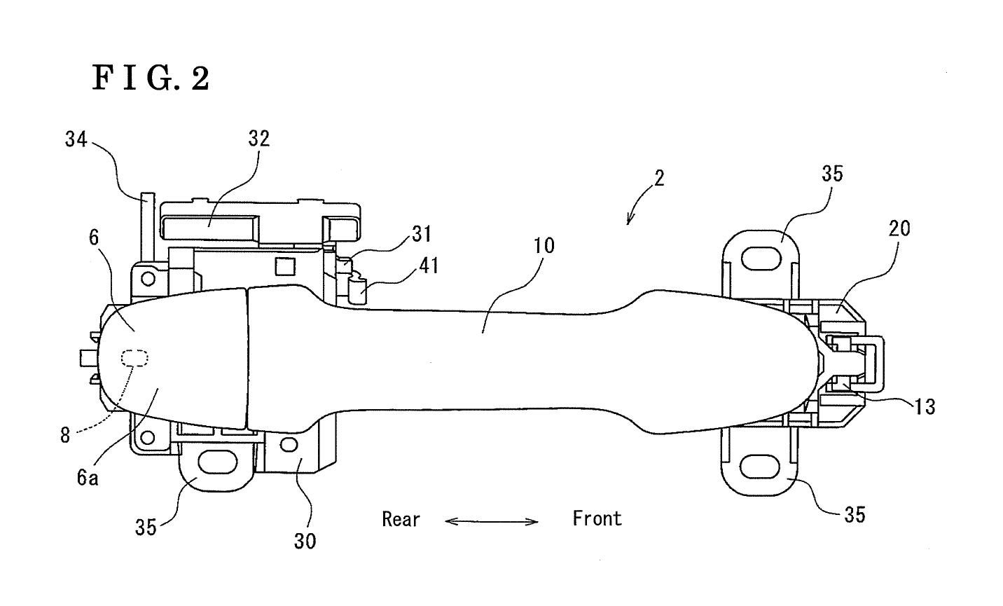

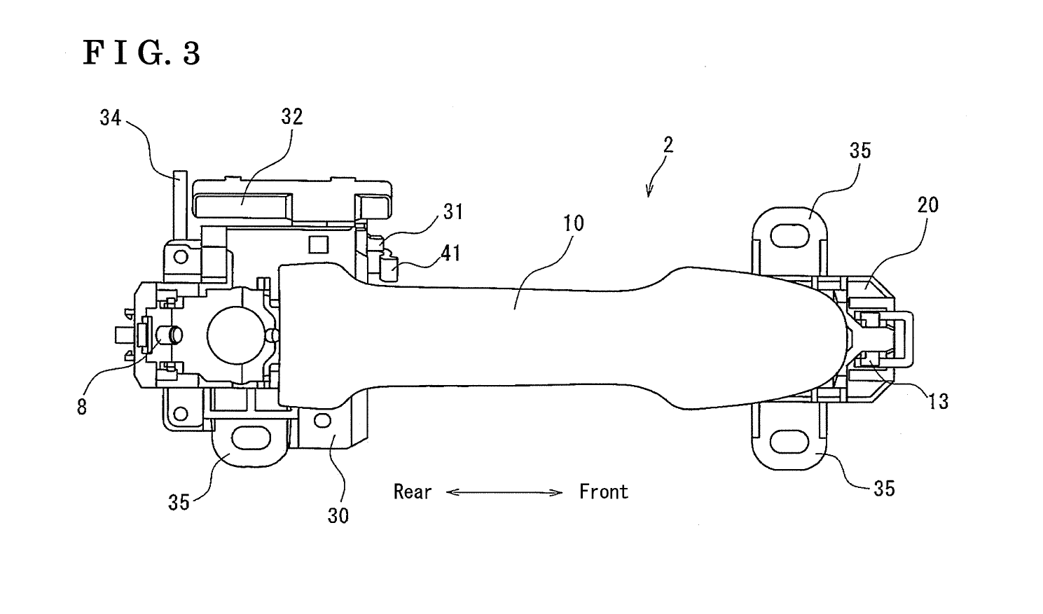

As illustrated in FIG. 2, a door handle device 2 serving as a door handle device for a vehicle according to the first embodiment includes the handle 10 and the cap 6 provided in the rear of the handle 10 in the longitudinal direction of the vehicle when externally viewed by a user of the vehicle. The door handle device 2 also includes a first frame 20 and a second frame 30 each serving as a frame so as to support the handle 10 and the cap 6 at the door panel 3. As illustrated in FIG. 3, harness support members 35, supporting bunched wire harnesses that are wired within the handle 10, are integrally formed at the first frame 20 and the second frame 30 respectively. The wire harnesses are bunched by harness binding members at bores formed at the harness support members 35 so as to be supported within the door panel 3.

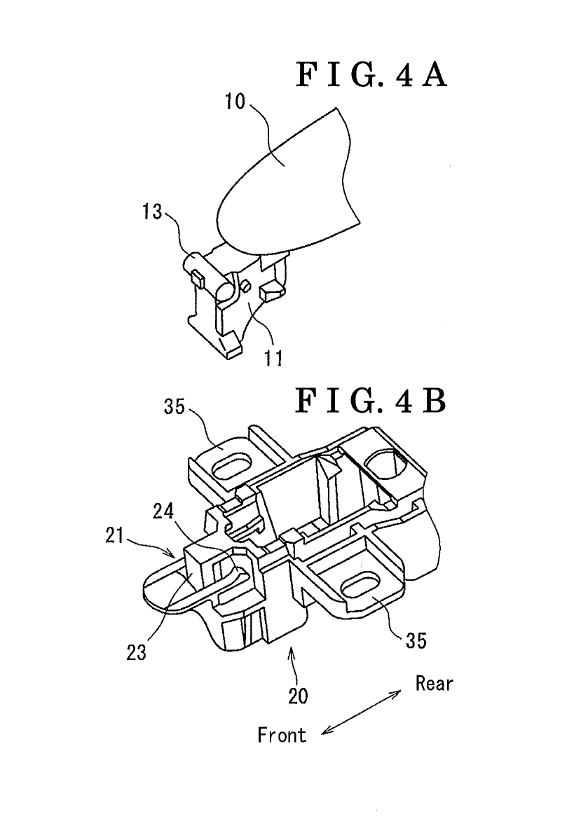

As illustrated in FIGS. 4A and 4B, an engagement leg portion 11 provided at the handle 10 includes a rotation shaft 13 substantially having a T-shape when viewed from a front side of the handle 10 in the longitudinal direction (i.e., at a first side of the handle 10 in the longitudinal direction). A bearing portion 21 provided at the first frame 20 includes a contact wall portion 23 and a projecting portion 24 both of which are integrally formed at the first frame 20. The contact wall portion 23 makes contact with the rotation shaft 13 when the handle 10 is slidably moved forward in the longitudinal direction to thereby restrict a further forward movement of the handle 10 in the longitudinal direction. That is, the contact wall portion 23 restricts the handle 10 from moving in the forward direction (i.e., the first side of the handle 10 in the longitudinal direction) by making contact with the rotation shaft 13 in association with a sliding movement of the handle 10 in the forward direction. The projecting portion 24 makes pressure contact with the rotation shaft 13 when the handle 10 is slidably moved forward in the longitudinal direction. The projecting portion 24 is elastically deformed to thereby allow the handle 10 to move forward in the longitudinal direction. That is, the projecting portion 24 is elastically deformed to allow the sliding movement of the handle 10 in the forward direction by making pressure contact with the rotation shaft 13 in association with the sliding movement of the handle 10 in the forward direction. The projecting portion 24 is then elastically returned so as to restrict the handle 10 from moving rearward in the longitudinal direction when the pressure contact state of the projecting portion 24 relative to the rotation shaft 13 is released at a position where the handle 10 is restricted from moving forward in the longitudinal direction thereof. That is, the projecting portion 24 is elastically returned to restrict the sliding movement of the handle 10 in the rearward direction (i.e., the second side of the handle 10 in the longitudinal direction) by a release of the pressure contact with the rotation shaft 13 at the position where the contact wall portion 23 restricts the sliding movement of the handle 10 in the forward direction. The projecting portion 24 and the contact wall portion 23 then operate together so as to support the rotation shaft 13 in a relatively rotatable manner.

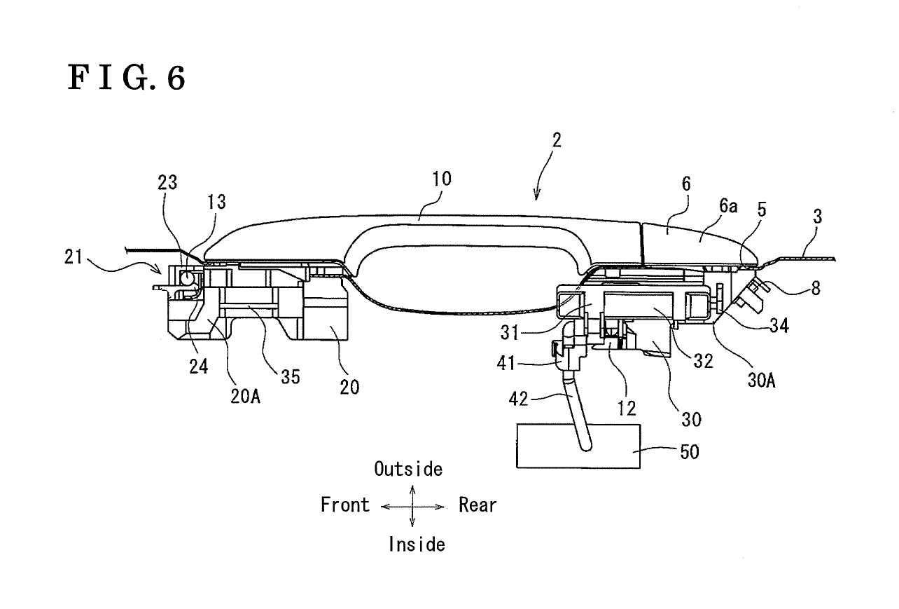

As illustrated in FIGS. 5 and 6, the handle 10 includes the engagement leg portion 11 at the front side (i.e., the first side) and an engagement arm portion 12 at the rear side (i.e., the second side). The engagement arm portion 12 is tapered towards an end thereof (i.e., a front end in the longitudinal direction of the handle 10). That is, the engagement arm portion 12 includes a tapered end portion.

The first frame 20 includes a frame portion 20A, the harness support members 35 and the bearing portion 21 rotatably supporting the rotation shaft 13. The frame portion 20A, which has a substantially rectangular parallelepiped shape, is symmetric in the vertical direction of the vehicle. The harness support members 35, each of which has a plate shape, are symmetrically provided at two portions in the vertical direction of the vehicle relative to the frame portion 20A. One of the harness support members 35 provided at a lower side supports the wire harnesses. The bearing portion 21 is symmetric in the vertical direction of the vehicle.

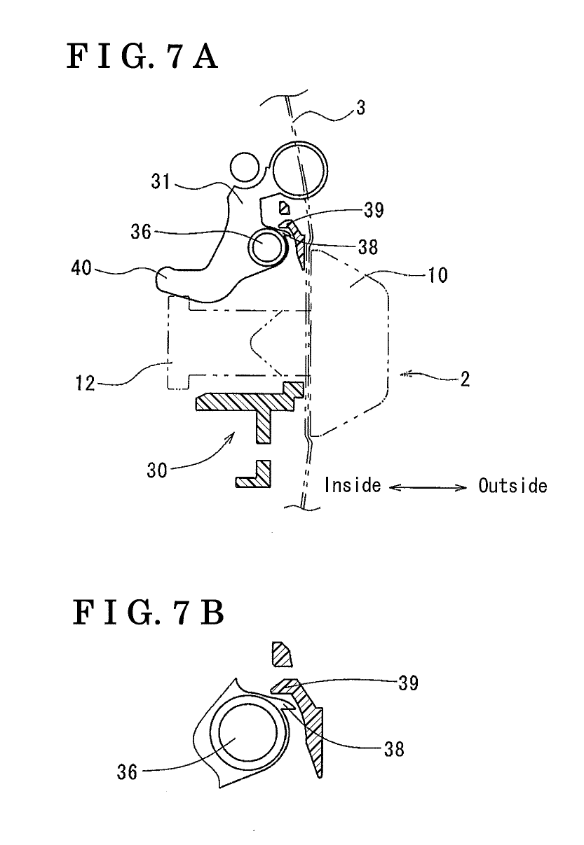

The second frame 30 includes a frame portion 30A, an arm 34, a second engagement hook 39 (see FIG. 7B), and a support portion 37. The frame portion 30A has a substantially rectangular parallelepiped shape enclosing therein the engagement arm portion 12 and serving as an outer frame of the second frame 30. The arm 34 extends to a higher position than a counterweight 32 while bending towards the counterweight 32 attached to a lever 31. The support portion 37 is provided at the frame portion 30A so as to rotatably connect the second frame 30 and a support shaft 36 of the lever 31.

The lever 31 includes the support shaft 36, the counterweight 32, a first engagement hook 38 (see FIGS. 7A and 7B), a lever input portion 40 (see FIG. 7A), a clip 41, and a link rod 42. The lever 31 rotates at the support shaft 36 so as to be connected to the engagement arm portion 12. The support shaft 36 is formed into a bar shape having a circular cross section. The support shaft 36 extends in the longitudinal direction of the vehicle.

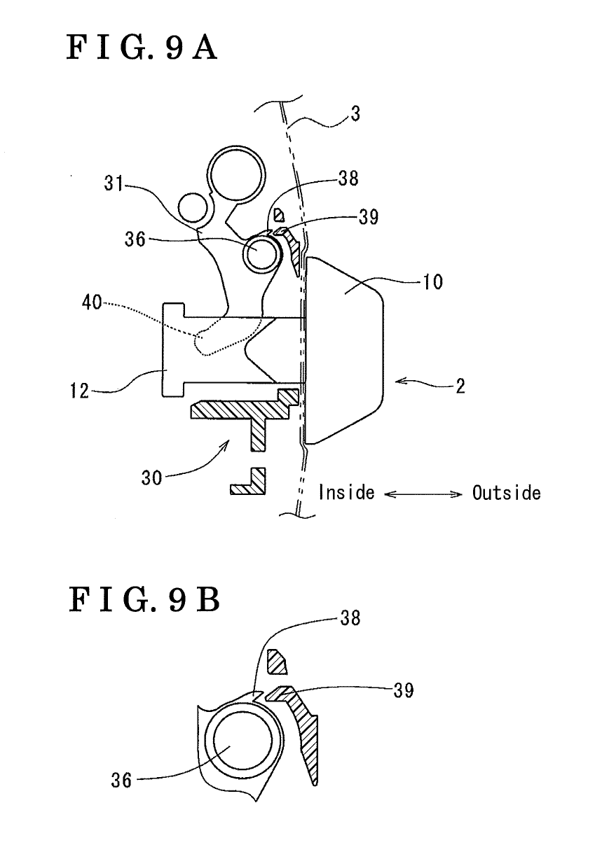

The counterweight 32 restricts the door lock mechanism 50 from unlocking in a case where a large impact is applied to the vehicle. The counterweight 32 having a column shape is provided at the lever 31. In addition, the counterweight 32 generates a force (specifically, an inertia moment) in a direction opposite from a direction where the lever 31 brings the door lock mechanism 50 to be unlocked (i.e., in a counterclockwise direction in FIG. 9A) in a case where a large impact is externally applied to a side surface of the door 1.

A spring 33 is provided around the support shaft 36 so as to bias the lever 31 in a rotation initial position.

The clip 41 has an end portion substantially formed into a U-shape when viewed from an inner side of the vehicle. The clip 41 extends in a downward direction of the door 1. The link rod 42 formed by a metallic bar is connected to the clip 41 at one end so as to extend in the downward direction of the door 1. The link rod 42 is connected to the door lock mechanism 50 at the other end. In a case where the handle 10 is pulled in an outward direction of the vehicle, the handle 10 rotates at the rotation shaft 13 so that the engagement arm portion 12 biases the lever input portion 40 of the lever 31 in the outward direction. Then, the lever 31 rotates at the support shaft 36 in a counterclockwise direction when viewed from the rear side of the vehicle. As a result, the clip 41 presses down the link rod 42 to thereby unlock the door lock mechanism 50.

FIGS. 7A and 7B are schematic views illustrating an assembly process of the door handle device according to the first embodiment. FIG. 7A illustrates a state where the lever 31 is assembled on the second frame 30. FIG. 7B illustrates details around the support shaft 36. As illustrated in FIGS. 7A and 7B, the first engagement hook 38 is formed in a projecting manner at an outer periphery of the support shaft 36. The second engagement hook 39 is provided in a projecting manner at an inner surface of the second frame 30. The second engagement hook 39 is elastically deformable by the first engagement hook 38 in a radially outward direction in a state where the lever 31 rotates by a predetermined amount or more from the rotation initial position. The lever input portion 40 of the lever 31 operates while sliding on the engagement arm portion 12.

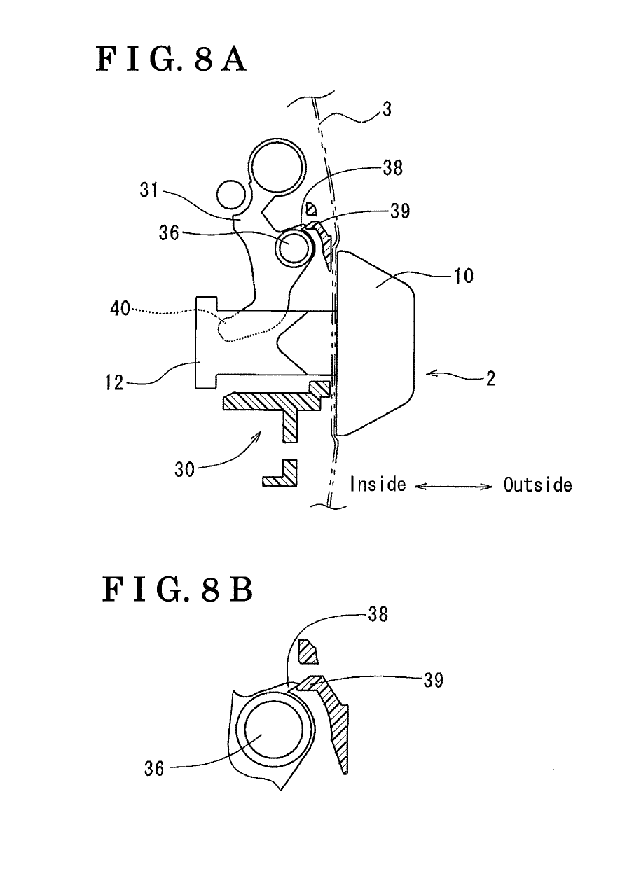

FIGS. 8A and 8B are schematic views illustrating the assembly process of the door handle device according to the first embodiment. FIG. 8A illustrates a state where the lever 31 is temporarily held at the second frame 30. FIG. 8B illustrates details around the support shaft 36. The first engagement hook 38 moves beyond the second engagement hook 39 while the second engagement hook 39 is elastically deformed in a radially outer direction. Then, the first engagement hook 38 and the second engagement hook 39 engage with each other by a biasing force of the spring 33. As a result, the lever 31 is temporarily held at the second frame 30.

FIGS. 9A and 9B are schematic views illustrating the assembly process of the door handle device according to the first embodiment. FIG. 9A illustrates a state where the engagement arm portion 12 and the lever input portion 40 are in contact with each other in a substantially horizontal direction. FIG. 9B illustrates details around the support shaft 36. A forward sliding movement of the engagement arm portion 12 in the longitudinal direction of the vehicle, in a state where the second frame 30 and the lever 31 are temporarily held, causes the lever input portion 40 to elastically ride on the engagement arm portion 12 from the tapered end portion so as to make contact with the engagement arm portion 12. As a result, the first engagement hook 38 is positioned to be slightly away from the second engagement hook 39.

An assembly operation according to the first embodiment will be explained below. In order to mount the door handle device 2 at the door panel 3, first, the lever 31 is attached to the second frame 30 as illustrated in FIGS. 5 and 6. The lever 31 is rotated by the predetermined amount or more from the rotation initial position against the biasing force of the spring 33. As illustrated in FIGS. 8A and 8B, the first engagement hook 38 moves beyond the second engagement hook 39 by elastically deforming the second engagement hook 39 so that the first engagement hook 38 is held at a temporarily holding position. Then, the first frame 20 is fixed to the door panel 3. The second frame 30 at which the lever 31 is temporarily held is fixed to the door panel 3. The engagement leg portion 11 and the engagement arm portion 12 are inserted into an opening portion 5 formed at the door panel 3.

Next, the rotation shaft 13 of the engagement leg portion 11 is slidably moved forward in the longitudinal direction of the handle 10 so that the rotation shaft 13 is fitted into the bearing portion 21 while elastically deforming the projecting portion 24. As a result, the rotation shaft 13 makes contact with the contact wall portion 23 and the projecting portion 24 that is elastically returned so as to restrict the sliding movement of the rotation shaft 13 in a rearward direction of the vehicle.

In the same way, the engagement arm portion 12 is slidably moved forward in the longitudinal direction of the handle 10 so that the lever input portion 40 elastically rides on the engagement arm portion 12 from the tapered end portion. In this case, the first engagement hook 38 is slightly away from the second engagement hook 39. Then, the handle 10 is assembled on the first frame 20 and the second frame 30 respectively. The cap 6 is thereafter attached and tightened to the second frame 30 by a screw 8 so as to partially cover the opening portion 5. In a state where the handle 10 and the cap 6 are assembled on the first and second frames 30, the cap 6 restricts the sliding movement of the handle 10 in the rearward direction of the vehicle. The cap 6 forms a decorative surface 6a continuously formed from and connected to an exterior surface of the handle 10.

According to the aforementioned first embodiment, the door handle device 2 includes the first frame 20 and the second frame 30 so as to eliminate a connection portion that is provided for a known frame in which a front portion and a rear portion are integrally formed by means of the connection portion. Thus, even in a case where a length of the handle 10 varies depending on vehicles, the adjustment of a relative position between the first frame 20 and the second frame 30 achieves the door handle device 2 of the present embodiment to be applicable to various vehicles. Accordingly, a versatility of the door handle device 2 of the present embodiment is improved. In addition, the cap 6 detachably engages with the second frame 30 and partially covers the opening portion 5 to thereby form the decorative surface 6a. Thus, because the second frame 30 is prevented from serving as a portion of the cap 6, changing or replacing of the second frame 30 is not required each time a design of the cap 6 changes. As a result, the versatility of the door handle device 2 of the present embodiment is further improved.

Further, according to the aforementioned first embodiment, the lever 31 and the second frame 30 are temporarily held at each other by the first engagement hook 38 and the second engagement hook 39. Thus, in a case of assembling the handle 10 on the second frame 30, the lever 31 is retracted from an access path of the engagement arm portion 12, which leads to an easy assembly of the engagement arm portion 12 of the handle 10 relative to the second frame 30. Further, because the lever input portion 40 presses the engagement arm portion 12 by the biasing force of the spring 33, looseness in the rotation direction of the handle 10 relative to the second frame 30 after the handle 10 is assembled on the second frame 30 may be restrained.

Furthermore, the bearing portion 21 supports the rotation shaft 13 formed at an end of the engagement leg portion 11 so as to be rotatable relative to the bearing portion 21 while restricting the engagement leg portion 11 from moving in the longitudinal direction of the handle 10. Thus, looseness in the longitudinal direction of the handle 10 relative to the first frame 20 may be restrained.

Furthermore, the handle 10 is assembled on the first frame 20 by being simply slid forward in the longitudinal direction of the handle 10. At this time, the handle 10 is restricted from moving further forward or rearward in the longitudinal direction by the contact wall portion 23 and the projecting portion 24. Therefore, a positioning error of the handle 10 in the forward or rearward direction may be restrained. Specifically, the contact wall portion 23 and the projecting portion 24 are integrally formed at the first frame 20, which leads to a reduction in the number of components, manufacturing hours, and a cost.

Furthermore, even when the window glass 7 that is assembled on the door 1 drops for some reasons, the window glass 7 makes contact with the arm 34. Therefore, the window glass 7 that drops may be prevented from hitting the counterweight 32, and the lever 31 may be prevented from rotating in the counterclockwise direction in FIG. 9. The door lock mechanism 50 is restrained from wrongly operating accordingly.

Furthermore, the harness support member 35 supporting the wire harnesses wired within the handle 10 is provided at least one of the first frame 20 and the second frame 30. Thus, the wire harnesses are restrained from moving within the door panel 3 while the vehicle is being driven.

Furthermore, the frame portion 20A, the harness support members 35, and the bearing portion 21 of the first frame 20 each include the symmetric configuration in the vertical direction of the vehicle so as to be applied to the door 1 either at a left or right side of the vehicle.

### Second Embodiment

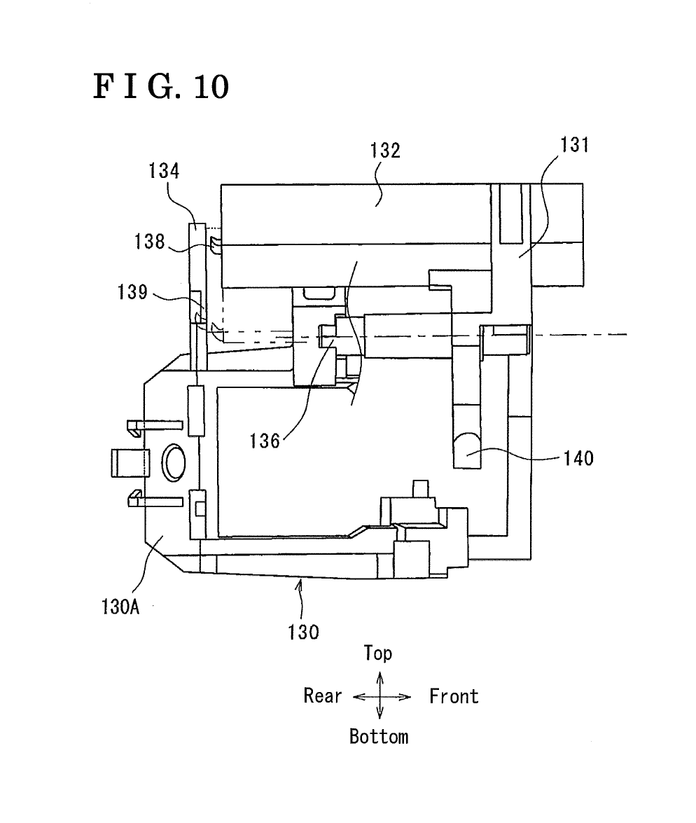

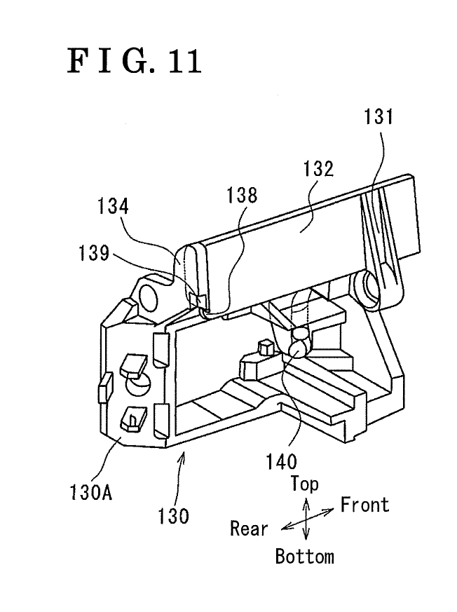

A second embodiment will be explained with reference to FIGS. 10 and 11. Components and configurations of the second embodiment same as those of the first embodiment bear the same reference numerals. A second frame 130 according to the second embodiment includes a frame portion 130A, an arm 134, and a second engagement hook 139. The frame portion 130A has a substantially rectangular parallelepiped shape enclosing therein the engagement arm portion 12 and serving as an outer frame of the second frame 130. The arm 134 having a plate shape extends from the frame portion 130A in a direction where a counterweight 132 is provided and in an upward direction of the vehicle. The second engagement hook 139 is formed at a bending portion of the arm 134 in a stepped manner. A lever 131 according to the second embodiment includes the counterweight 132, a support shaft 136, a first engagement hook 138, and a lever input portion 140. The lever 131 rotates relative to the support shaft 136 and operates in association with the engagement arm portion 12. The lever 131 is biased by a spring in a rotation initial position and in the forward direction of the vehicle.

As illustrated in FIG. 11, in a state where the lever 131 is temporarily held at the second frame 130, the first engagement hook 138 engages with the second engagement hook 139.

An assembly operation according to the second embodiment will be explained below. First, the lever 131 is attached to the second frame 130. The lever 131 is then rotated and moved to a position illustrated by a dashed line and a thin line in FIG. 10 against a biasing force of the spring so that the first engagement hook 138 engages with the second engagement hook 139 as illustrated in FIG. 11. The lever 131 is positioned at a temporarily holding position so that the second frame 130 and the lever 131 are temporarily held at each other. Then, the first frame 20 is fixed to the door panel 3. The second frame 130, at which the lever 131 is temporarily held, is fixed to the door panel 3. The engagement leg portion 11 and the engagement arm portion 12 of the handle 10 are then inserted into respective insertion portions of the door panel 3.

Next, the engagement arm portion 12 is slid in the forward direction of the vehicle (i.e., in a rightward direction in FIG. 10) and thereafter the handle 10 is fully rotated (i.e., a full stroke of the handle 10 is obtained) while the lever input portion 140 and the engagement arm portion 12 are in contact with each other. As a result, the temporarily holding state between the first engagement hook 138 and the second engagement hook 139 is released so that the lever 131 moves in the forward direction of the vehicle by the biasing force of the spring. Then, the handle 10 is assembled on the first frame 20 and the second frame 130. The cap 6 is thereafter attached and tightened to the second frame 30 by the screw 8. The other assembly operation according to the second embodiment is the same as that of the first embodiment.

According to the aforementioned second embodiment, the door handle device 2 includes the first frame 20 and the second frame 130 so as to eliminate a connection portion that is provided for a known frame in which a front portion and a rear portion are integrally formed by means of the connection portion. Thus, even in a case where a length of the handle 10 varies depending on vehicles, the adjustment of a relative position between the first frame 20 and the second frame 130 achieves the door handle device 2 of the present embodiment to be applicable to various vehicles. Accordingly, a versatility of the door handle device 2 of the present embodiment is improved. In addition, the cap 6 detachably engages with the second frame 130 and partially covers the opening portion 5 to thereby form the decorative surface 6a. Thus, because the second frame 130 is prevented from serving as a portion of the cap 6, changing or replacing of the second frame 130 is not required each time a design of the cap 6 changes. As a result, the versatility of the door handle device 2 of the present embodiment is further improved.

Further, according to the aforementioned second embodiment, the lever 131 and the second frame 130 are temporarily held at each other by the first engagement hook 138 and the second engagement hook 139. Thus, in a case of assembling the handle 10 on the second frame 130, the lever 131 is retracted from an access path of the engagement arm portion 12, which leads to an easy assembly of the engagement arm portion 12 of the handle 10 relative to the second frame 130. Further, because the lever input portion 140 presses the engagement arm portion 12 by the biasing force of the spring, looseness in the rotation direction of the handle 10 relative to the second frame 130 after the handle 10 is assembled on the second frame 130 may be restrained. The other effects of the second embodiment are the same as those of the first embodiment.

According to the aforementioned first and second embodiments, alternatively, the door handle device 2 of the first and second embodiments may be applied to the door handle of a slide door, a hatch door, a gull-wing door, bi-parting doors, and the like.

According to the aforementioned first and second embodiments, the door handle device 2 is applied to the handle 10 of the door 1 at a front side of the vehicle. Alternatively, the door handle device 2 of the first and second embodiments may be applied to the door handle of a door at a rear side of the vehicle.

The arm 34 provided at the second frame 30 so as to restrain the window glass 7 from making contact with the counterweight 32 according to the first embodiment may be provided at the first frame 20 or may be omitted.

According to the first and second embodiments, the two harness support members 35 are provided at the first frame 20 and the one harness support member 35 is provided at the second frame 30. In this case, the number of harness support members 35 provided at the first and second frames 20 and 30 may increase or decrease, or the harness support members 35 may be omitted.

The first and second embodiments are not limited to have the aforementioned configurations and may be appropriately modified or changed.

According to the aforementioned embodiment, the door handle device 2 includes the handle 10 serving as a grip portion for opening and closing the door 1 for the vehicle and including the engagement leg portion 11 and the engagement arm portion 12 at the front side and the rear side (the first side and the second side) in the longitudinal direction of the handle 10, the first frame 20 configured to be attached to the door panel 3 of the door 1 and including the bearing portion 21 serving as a rotation center of the engagement leg portion 11, the lever 31 configured to transmit an opening operation force of the door 1 to the door lock mechanism 50 holding the door 1 at the fully closed position by operating with the engagement arm portion 11, the second frame 30 configured to be attached to the door panel 3 and supporting the lever 31 to rotate at the support shaft 36, and the cap 6 engaging with the second frame 30 in a detachable manner and formed at the rear side of the handle 10 in the longitudinal direction, the cap 6 being configured to cover the opening portion 5 formed at the door panel 3 through which the engagement arm portion Ills inserted.

In addition, the door handle device 2 further includes the spring 33 biasing the lever 31 to the rotation initial position, wherein the lever 31 includes the first engagement hook 38 and the second frame 30 includes the second engagement hook 39, the first engagement hook 38 engaging with the second engagement hook 39 to temporarily hold the lever 31 in a state where the lever 31 is rotated by a predetermined amount from the rotation initial position against a biasing force of the spring 33.

Further, the engagement leg portion 11 includes the rotation shaft 13 at the end, the rotation shaft 13 engaging with the first frame 20 to be relatively rotatable, and wherein the bearing portion 21 supports the rotation shaft 13 to be relatively rotatable while restricting the engagement leg portion 11 from moving to the front side (the first side) of the handle 10 in the longitudinal direction.

Furthermore, the bearing portion 21 includes the contact wall portion 23 and the projecting portion 24, the contact wall portion 23 being integrally formed at the first frame 20 and restricting the handle 10 from moving to the front side (the first side) of the handle 10 in the longitudinal direction by making contact with the rotation shaft 13 in association with a sliding movement of the handle 10 to the front side in the longitudinal direction, the projecting portion 24 being integrally formed at the first frame 20 where the contact wall portion 23 is formed and elastically deformed to allow the sliding movement of the handle 10 to the front side in the longitudinal direction by making pressure contact with the rotation shaft 13 in association with the sliding movement of the handle 10 to the front side in the longitudinal direction, the projecting portion 24 being elastically returned to restrict the sliding movement of the handle 10 to the rear side (the second side) in the longitudinal direction by a release of the pressure contact with the rotation shaft 13 at a position where the contact wall portion 23 restricts the sliding movement of the handle 10 to the front side in the longitudinal direction, the projecting portion 24 operating with the contact wall portion 23 to support the rotation shaft 13 to be relatively rotatable.

Furthermore, either one of the first frame 20 and the second frame 30 includes the arm 34 extending to a position higher than a position where the counterweight 32 attached to the lever 31 is provided.

Furthermore, either one of the first frame 20 and the second frame 30 includes the harness support member 35 supporting the wire harness that is wired within the handle 10.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door handle device for a vehicle, comprising:
a handle serving as a grip portion for opening and closing a door for the vehicle and including an engagement leg portion and an engagement arm portion at a first side and a second side respectively in a longitudinal direction of the handle;
a first frame configured to be attached to a door panel of the door and including a bearing portion serving as a rotation center of the engagement leg portion;
a lever configured to transmit an opening operation force of the door to a door lock mechanism holding the door at a fully closed position by operating with the engagement arm portion;
a second frame configured to be attached to the door panel and supporting the lever to rotate at a support shaft; and
a cap engaging with the second frame in a detachable manner and formed at the second side of the handle in the longitudinal direction, the cap being configured to cover an opening portion formed at the door panel through which the engagement arm portion is inserted.

2. The door handle device according to claim 1, further comprising a spring biasing the lever to a rotation initial position, wherein the lever includes a first engagement hook and the second frame includes a second engagement hook, the first engagement hook engaging with the second engagement hook to temporarily hold the lever in a state where the lever is rotated by a predetermined amount from the rotation initial position against a biasing force of the spring.

3. The door handle device according to claim 1, wherein the engagement leg portion includes a rotation shaft at an end, the rotation shaft engaging with the first frame to be relatively rotatable, and wherein the bearing portion supports the rotation shaft to be relatively rotatable while restricting the engagement leg portion from moving to the first side of the handle in the longitudinal direction.

4. The door handle device according to claim 2, wherein the engagement leg portion includes a rotation shaft at an end, the rotation shaft engaging with the first frame to be relatively rotatable, and wherein the bearing portion supports the rotation shaft to be relatively rotatable while restricting the engagement leg portion from moving to the first side of the handle in the longitudinal direction.

5. The door handle device according to claim 3, wherein the bearing portion includes a contact wall portion and a projecting portion, the contact wall portion being integrally formed at the first frame and restricting the handle from moving to the first side of the handle in the longitudinal direction by making contact with the rotation shaft in association with a sliding movement of the handle to the first side in the longitudinal direction, the projecting portion being integrally formed at the first frame where the contact wall portion is formed and elastically deformed to allow the sliding movement of the handle to the first side in the longitudinal direction by making pressure contact with the rotation shaft in association with the sliding movement of the handle to the first side in the longitudinal direction, the projecting portion being elastically returned to restrict the sliding movement of the handle to the second side in the longitudinal direction by a release of the pressure contact with the rotation shaft at a position where the contact wall portion restricts the sliding movement of the handle to the first side in the longitudinal direction, the projecting portion operating with the contact wall portion to support the rotation shaft to be relatively rotatable.

6. The door handle device according to claim 4, wherein the bearing portion includes a contact wall portion and a projecting portion, the contact wall portion being integrally formed at the first frame and restricting the handle from moving to the first side of the handle in the longitudinal direction by making contact with the rotation shaft in association with a sliding movement of the handle to the first side in the longitudinal direction, the projecting portion being integrally formed at the first frame where the contact wall portion is formed and elastically deformed to allow the sliding movement of the handle to the first side in the longitudinal direction by making pressure contact with the rotation shaft in association with the sliding movement of the handle to the first side in the longitudinal direction, the projecting portion being elastically returned to restrict the sliding movement of the handle to the second side in the longitudinal direction by a release of the pressure contact with the rotation shaft at a position where the contact wall portion restricts the sliding movement of the handle to the first side in the longitudinal direction, the projecting portion operating with the contact wall portion to support the rotation shaft to be relatively rotatable.

7. The door handle device according to claim 1, wherein either one of the first frame and the second frame includes an arm extending to a position higher than a position where a counterweight attached to the lever is provided.

8. The door handle device according to claim 1, wherein either one of the first frame and the second frame includes a harness support member supporting a wire harness that is wired within the handle.
